(19) United States
(12) Patent Application Publication
(10) Pub. No.: US 2026/0339829 A1
(43) Pub. Date: Oct. 29, 2026

(54) ELECTRONIC CONTROL UNIT, VEHICLE CONTROL SYSTEM, AND SOFTWARE VERIFICATION METHOD

(71) Applicant: Hitachi Astemo, Ltd., Hitachinaka-shi, Ibaraki (JP)

(72) Inventor: Masakazu IKEDA, Hitachinaka-shi, Ibaraki (JP)

(73) Assignee: Hitachi Astemo, Ltd., Hitachinaka-shi, Ibaraki (JP)

(21) Appl. No.: 19/111,585

(22) PCT Filed: Sep. 30, 2022
(86) PCT No.: PCT/JP2022/036683

§ 371 Date: Mar. 13, 2025

(51) Int. Cl. G06F 11/3668

(52) U.S. Cl. CPC G06F 11/3692

(57) ABSTRACT

An electronic control unit includes: first software that executes arithmetic processing based on time-series sensor information, a processing result of the first software being used for vehicle control; second software that is executed in parallel with the first software and outputs a result of the arithmetic processing based on the sensor information, the processing result of the second software being not used for vehicle control; a comparison unit that compares the processing result of the first software with the processing result of the second software; and a transmission determination unit that determines to transmit, to the verification system, sensor information corresponding to a processing result determined as a mismatch by the comparison unit, and further to transmit, to the verification system, sensor information corresponding to a processing result determined as a match by the comparison unit according to a number of pieces of information acquired from the sensor information.

### TECHNICAL FIELD

The present invention relates to an electronic control unit.

### BACKGROUND ART

In recent years, a vehicle is equipped with a plurality of electronic control units (ECUs). With advancement of automatic driving, complication of control software has also progressed, and a plurality of electronic control units each mounted with control software cooperatively realize one in-vehicle application.

In order to realize high-quality control software, exhaustive verification in a test on actual machine is ideal, but an evaluation that satisfies the sufficiency of covering all conditions is not realistic.

The background art of the present technical field includes the following prior art. PTL 1 (JP 2022-13187 A) describes a vehicle control device including: a verification management unit that executes a previous control software unit, which indicates control software of a previous version, and a new control software unit, which indicates control software of a new version, in parallel; and an output verification unit that outputs information indicating a mismatch in a case where the output of the previous control software unit and the output of the new control software unit correspond to a mismatch.

### CITATION LIST

### Patent Literature

PTL 1: JP 2022-13187 A

### SUMMARY OF INVENTION

### Technical Problem

In PTL 1, the previous control software unit and the new software unit calculate recognition processing, route planning, and control commands on the basis of input sensor values. In addition, the outputs of the previous control software unit and the new control software unit are compared, and in a case where the outputs of the two control software units do not match, the information indicating a mismatch is output.

In a case where the technology described in PTL 1 is applied to output comparison of recognition processing of control software, there is a possibility that erroneous detection or non-detection occurs, and thus, extracting only a case where the outputs do not match is insufficient for evaluating the software.

### Solution to Problem

In order to solve the above-described problems, a representative example of the invention disclosed in the present application is as follows. That is, an electronic control unit that controls a vehicle includes: a processor that executes software; and a storage device that stores the software. The electronic control unit is connected to a verification system that verifies software by using information from the electronic control unit, and the electronic control unit further includes: first software that executes arithmetic processing based on time-series sensor information, a processing result of the first software being used for vehicle control; second software that is executed in parallel with the first software and outputs a result of the arithmetic processing based on the sensor information, the processing result of the second software being not used for vehicle control; a comparison unit that compares the processing result of the first software with the processing result of the second software; and a transmission determination unit that determines to transmit, to the verification system, sensor information corresponding to a processing result determined as a mismatch by the comparison unit, and further to transmit, to the verification system, sensor information corresponding to a processing result determined as a match by the comparison unit according to a number of pieces of information acquired from the sensor information.

### Advantageous Effects of Invention

According to an aspect of the present invention, the quality of software can be improved. Problems, configurations, and effects other than those described above will be clarified by the following description of embodiments.

### BRIEF DESCRIPTION OF DRAWINGS

FIG. 1 is a block diagram illustrating a configuration of an electronic control unit according to a first embodiment.

FIG. 2 is a flowchart of processing executed by the electronic control unit according to the first embodiment.

FIG. 3 is a diagram illustrating a comparison correspondence table in which an output comparison unit of the first embodiment compares detection results.

FIG. 4 is a block diagram of an external reprocessing unit of the first embodiment.

FIG. 5 is a flowchart of processing executed by the external reprocessing unit of the first embodiment.

FIG. 6 is a flowchart of processing executed by the electronic control unit according to a second embodiment.

FIG. 7 is a block diagram illustrating a configuration of an electronic control unit according to a third embodiment.

FIG. 8 is a block diagram illustrating a configuration of an electronic control unit according to a fourth embodiment.

FIG. 9 is a flowchart of processing executed by the electronic control unit according to the fourth embodiment.

FIG. 10 is a flowchart of processing executed by an electronic control unit of a fifth embodiment.

FIG. 11 is a configuration diagram of a vehicle control system according to the embodiment of the present invention.

FIG. 12 is a timing chart from a sensor input to an output of a sensor value according to the first embodiment.

FIG. 13 is a timing chart from a sensor input to an output of a sensor value according to the second embodiment.

### DESCRIPTION OF EMBODIMENTS

Hereinafter, embodiments of the present invention will be described.

### First Embodiment

### Electronic Control Unit: Number of Detected Objects

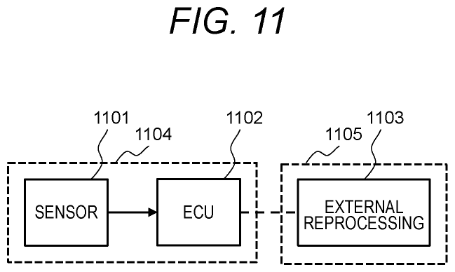

FIG. 11 is a configuration diagram of a vehicle control system according to an embodiment of the present invention.

The vehicle control system includes a sensor 1101 that observes an outside of a vehicle, an electronic control unit (ECU) 1102, and an external reprocessing unit 1103 provided in a server or a cloud. The sensor 1101 and the electronic control unit 1102 are disposed in a vehicle 1104 and connected by a communication line of a high-speed protocol such as Ethernet (registered trademark). In addition, the external reprocessing unit 1103 is disposed in an external server 1105 and is connected to the electronic control unit 1102 via a wireless communication line. The external reprocessing unit 1103 will be described as being in the external server 1105, but may be provided in an electronic control unit in the vehicle.

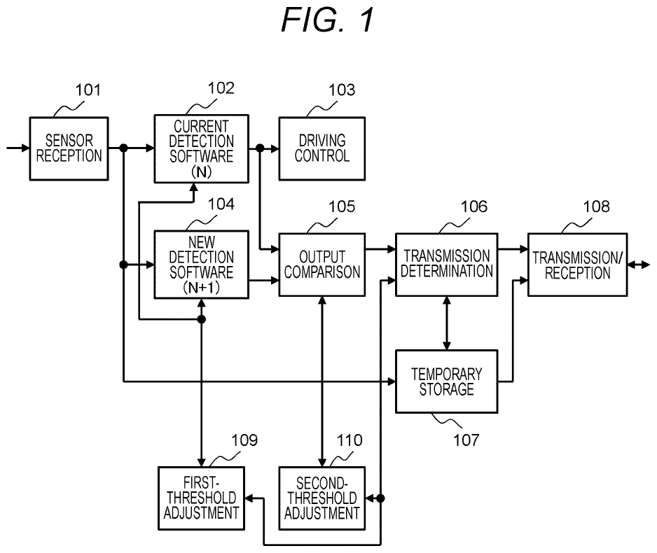

FIG. 1 is a block diagram illustrating a configuration of the electronic control unit 1102.

The electronic control unit 1102 includes a sensor reception unit 101, a current detection software unit 102, a driving control unit 103, a new detection software unit 104, an output comparison unit 105, a transmission determination unit 106, a temporary storage unit 107, a transmission/reception unit 108, a first-threshold adjustment unit 109, and a second-threshold adjustment unit 110.

The current detection software unit 102 is equipped with current (Version N) object detection software, and the new detection software unit 104 is equipped with new (Version N+1) object detection software different from the current software. The sensor reception unit 101 receives a sensor image from the sensor 1101, the current detection software unit 102 detects an object from the sensor image, and the driving control unit 103 executes processing such as recognition, route planning, and control commands to realize automatic driving. The sensor image input from the sensor 1101 is added with information for identifying the sensor 1101 that has acquired the sensor image, and attribute information, such as a photographing time and a photographing place, for identifying a frame image.

In addition, the new detection software unit 104 also executes object detection processing, the output comparison unit 105 compares object detection results output from the current detection software unit 102 and the new detection software unit 104, and the transmission determination unit 106 determines whether to output an input sensor value on the basis of the output comparison result. For example, when the output comparison unit 105 detects a mismatch between two object detection results, it is preferable to output the input sensor value. The sensor value may be output to the outside after the transmission/reception unit 108 converts the input sensor value temporarily stored in the temporary storage unit 107 such as a memory into an appropriate protocol. The current detection software unit 102 and the new detection software unit 104 count the number of objects detected in the object detection processing to be executed, and compare the number with a detection threshold set in advance by the first-threshold adjustment unit 109. In addition, the output comparison unit 105 detects a mismatch between the object detection results of the current detection software unit 102 and the new detection software unit 104 according to a comparison threshold set in advance by the second-threshold adjustment unit 110. For example, “object detection” is a case where “a certain object can be detected with a seemingly reliable degree of reliability”, and it is preferable to output coordinates indicating a rectangular boundary line (bounding box) indicating the position of the object. In addition, “detection present” is a case where “one or more objects are detected from a certain sensor image”, “detection abundant” is a case where “the number of objects detected from a certain sensor image is equal to or larger than a predetermined detection threshold”, and “comparison match” is a case where “the degree of overlapping of the detection values (bounding boxes) of both pieces of detection software is equal to or larger than a predetermined comparison threshold, and the types of the detected objects is the same”.

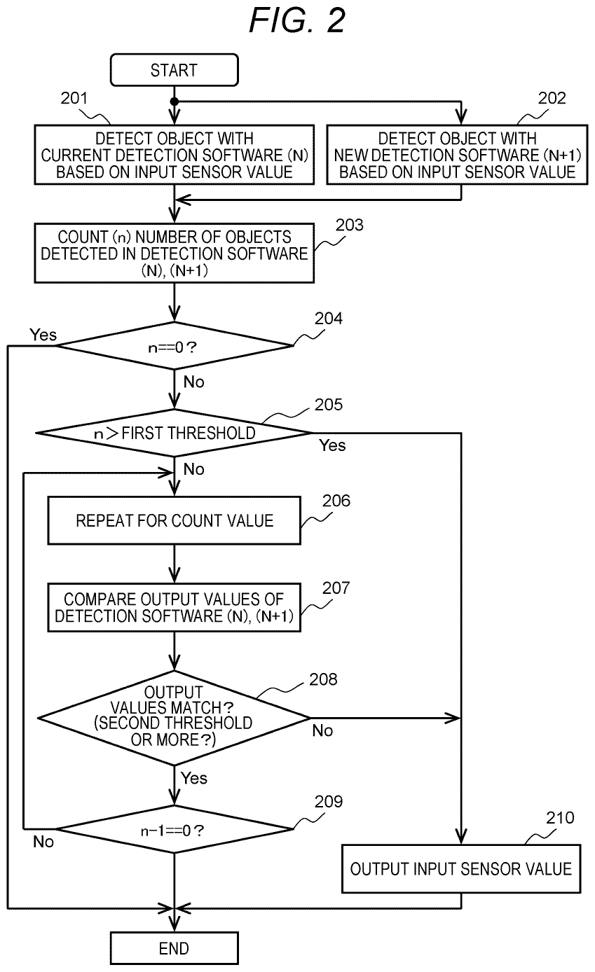

FIG. 2 is a flowchart of processing executed by the electronic control unit 1102. A flow of processing in the electronic control unit 1102 of FIG. 1 will be described with reference to FIG. 2.

The current detection software unit 102 detects an object from an input sensor value with software of Version. N (201), and the new detection software unit 104 detects an object from the input sensor value with software of Version. N+1 (202). Next, the first-threshold adjustment unit 109 counts the number 0 objects detected by each object detection software, and instead of obtaining, as a total count value n, the sum of the numbers, counts objects estimated to be the same place and the same object in both as 1 (203). Although not particularly limited herein, the number of detected objects (for example, other vehicles, pedestrians, and the like) that are likely to be involved in automatic driving may be used. In a case where no object is detected (n=0), the process ends without any processing, and in a case where something is detected, the subsequent processing is executed (204).

The transmission determination unit 106 determines whether the total count value n of the numbers of detected objects are equal to or larger than a predetermined first threshold (detection threshold) (205), and when the total count value n are equal to or larger than the first threshold, outputs the input sensor value without comparing the outputs of both pieces of software (210). The object detection number determination processing may be performed in all the times, or may be performed in a predetermined time after the output mismatch is detected. In the latter case, it is estimated that erroneous detection or non-detection is made in any software when the output mismatch is detected, and there is a high possibility that erroneous detection or non-detection occurs in both pieces of software also in the subsequent image. In this regard, an output of an image for a predetermined time after mismatch detection or an image in which a predetermined number or more of objects are detected may be set as a target. In addition, the first threshold (detection threshold) to be compared with the number of detected objects may be a fixed value determined by initial setting, or may be determined in consideration of the number of detected objects in a case where a mismatch is detected. Furthermore, an image in a predetermined period before and after an image in which a mismatch is detected, instead of the predetermined period after mismatch detection, may be set as a target.

Next, the output comparison unit 105 repeatedly executes subsequent detection output comparison processing for the total count value n (206). In the detection output comparison processing (207), the degree of overlap of detection coordinates output from each software is evaluated, and a match is determined in a case where the overlap is equal to or larger than a predetermined second threshold (comparison threshold) or more. If the comparison results of all the detected objects of the total count value n are matches, the transmission determination unit 106 ends the processing (209). On the other hand, in a case where at least one mismatch is detected, an input sensor value is output (210). As a result, it is possible to output, to the outside, the input sensor image of a case where the number of detected objects is a certain threshold or more, in addition to a case where the presence of a mismatch is detected. Note that, when the input sensor value is output to the outside, in addition to the sensor image of an observation time, an observation place, or the like, determination information such as presence or absence of mismatch detection, degradation, and improvement may be added as attribute information and transmitted, which facilitates management and identification of data by an external server or the like. In addition, although not described in the electronic control unit 1102 of FIG. 1, if surrounding conditions such as weather and brightness, traveling conditions of the host vehicle such as general roads, expressways, and intersections, road conditions such as traffic congestion, broken vehicles, and road damage, driving conditions such as lights, speeds, and brake operations, and characteristics (proficiency, physical condition, and the like) of the driver are detected, and these are added as attribute information and transmitted, the management and the identification may be further facilitated.

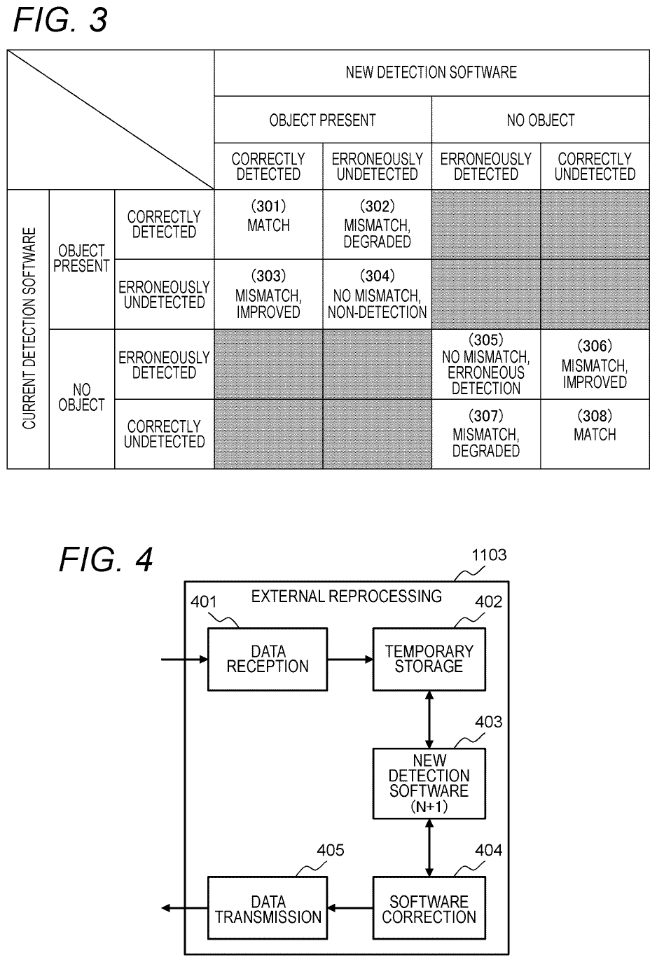

FIG. 3 is a diagram illustrating a comparison correspondence table in which the output comparison unit 105 compares detection results. In both pieces of software, if an object is present and is correctly detected (pattern 301), or if an object is not present and correctly undetected (pattern 308), the output results can be determined as a match. On the other hand, a modification status of the software in the case of detecting a mismatch varies depending on the presence or absence of an object. In a case where an object is present and a mismatch is detected, when non-detection occurs in the current detection software and detection occurs in the new detection software, it can be determined that the detection software is “improved” (pattern 303), and when detection occurs in the current detection software and non-detection occurs in the new detection software, it can be determined that the detection software is “degraded” (pattern 302). In addition, in a case where an object is not present and a mismatch is detected, when non-detection occurs in the current detection software and detection occurs in the new detection software, it can be determined that the detection software is “degraded” (pattern 307), and when detection occurs in the current detection software and non-detection occurs in the new detection software, it can be determined that the detection software is “improved” (pattern 306). In this regard, in a case where the detection software is “degraded”, the input sensor value may be output. In addition, in a case where an object is present and a match is detected, there is a case where non-detection occurs in both pieces of software (pattern 304), and in a case where an object is not present and a match is detected, there is a case where erroneous detection occurs in both pieces of software (pattern 305). In this case, it may fail to extract a problematic image if the conditions for outputting the input sensor value are not satisfied. In this regard, in the present embodiment, as an example of a case where the problem remains, it is preferable to output, as an edge case, an image in which the number of detected objects is larger than or equal to a certain threshold and the objects are likely to complicatedly overlap each other.

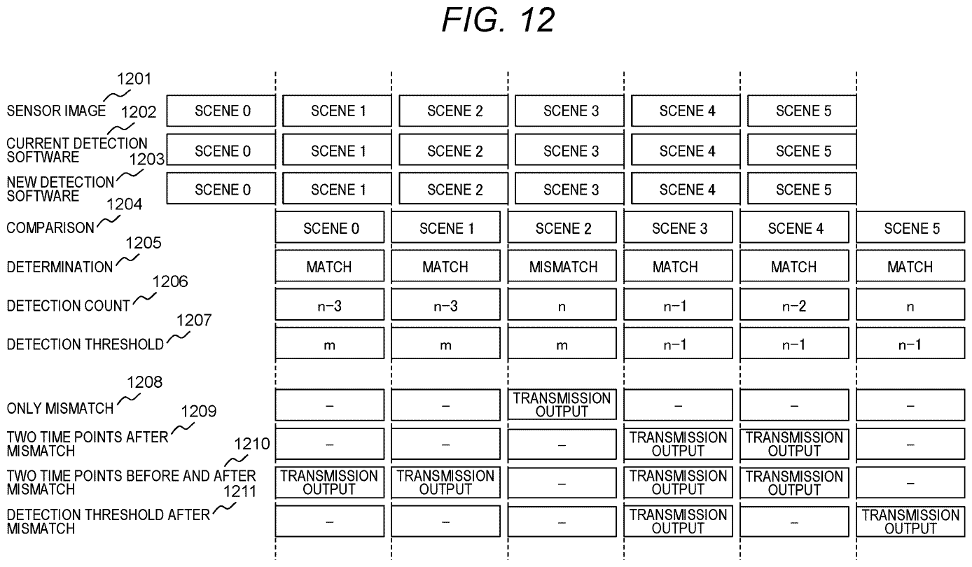

FIG. 12 is a timing chart from a sensor input to an output of a sensor value. For example, a case will be described in which images of scenes 0 to 5 are input as an input sensor image 1201, and processing is executed at each stage of current detection software 1202, new detection software 1203, comparison 1204, determination 1205, detection of a detection count 1206, and control of a detection threshold 1207. Here, a processing start timing and a processing end timing are simply illustrated, and in practice, a timing (for example, an execution time of software) may vary depending on an implementation method of hardware or software. In addition, the detection threshold is set to (detection count—1) with reference to the detection count at the time of mismatch detection. When it is determined to output only the mismatch detection as in a conventional method (1208), only “scene 2” is determined as a transmission image. When a certain period (two time points) after the mismatch detection 1209 is set, “scene 3” and “scene 4” are also determined as output images, and when a certain period (two time points before and after) before and after the mismatch detection 1210 is set, “scene 0” and “scene 1” are also determined as output images. In addition, on the condition that the detection count exceeds the detection threshold after the mismatch detection 1211, “scene 3” and “scene 5” are determined as output images. In this manner, suspicious cases before and after the mismatch detection can be output as edge cases.

The output input sensor value is sent to, for example, a server or the like and appropriately managed. FIG. 4 is a block diagram of the external reprocessing unit 1103. The input sensor value output from the electronic control unit 1102 is stored in a temporary storage unit 402 provided in a memory area via a data reception unit 401. The memory area is a storage area in the server, and hardware and a medium constituting the storage area are not limited. Re-verification by the software 403 equivalent to the new detection software on the server can contribute to improvement of the quality of the software. In addition, the software is improved by a software correction unit 404 by using an image in which a problem occurs in the detection, the improved software is transmitted from the data transmission unit 405, and the software of the electronic control unit 1102 is rewritten.

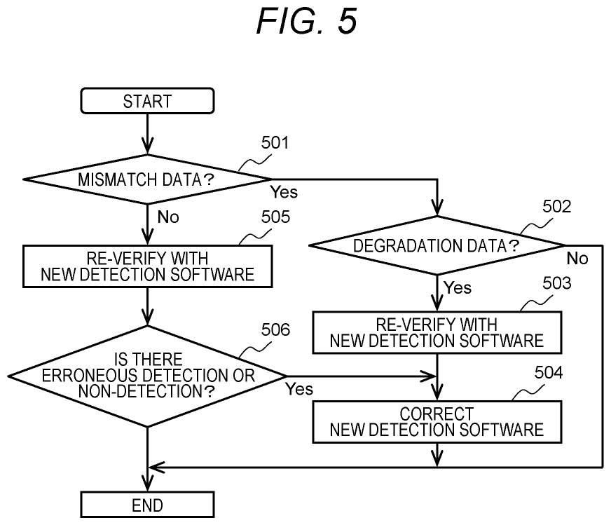

FIG. 5 is a flowchart of processing executed by the external reprocessing unit 1103. First, it is determined whether the input sensor value is mismatch data, based on the identification information of the input sensor value (501). In a case where the input sensor value is mismatch data, it is determined whether improvement or degradation occurs (502). If the input sensor value of degradation data, the image thereof is used to perform re-verification (503) in the new detection software, and correction of the detection software is attempted (504).

On the other hand, in a case where the input sensor value is not mismatch data, re-verification (505) is performed in the new detection software, and it is determined whether there is a problem such as erroneous detection or non-detection (506). As a result, if there is a problem, correction of the new detection software is attempted (504). This can improve the quality of the software. Here, it has been described that the mismatch data of improvement is processed so as not to be transmitted on the electronic control unit 1102 side or is excluded on the server side, but an image of the mismatch data of improvement may be used as a reference for correction of the new detection software.

### Second Embodiment

Next, a second embodiment of the present invention will be described. In the second embodiment, the transition of the number of detected objects is monitored (601) without comparing (205) the number of detected objects with the first threshold in the first embodiment (FIG. 2). Note that, in the second embodiment, differences from the first embodiment will be mainly described, and the same configurations and processing as those in the first embodiment will be denoted by the same reference numerals, and description thereof will be omitted.

### Electronic Control Unit: Object Detection Transition

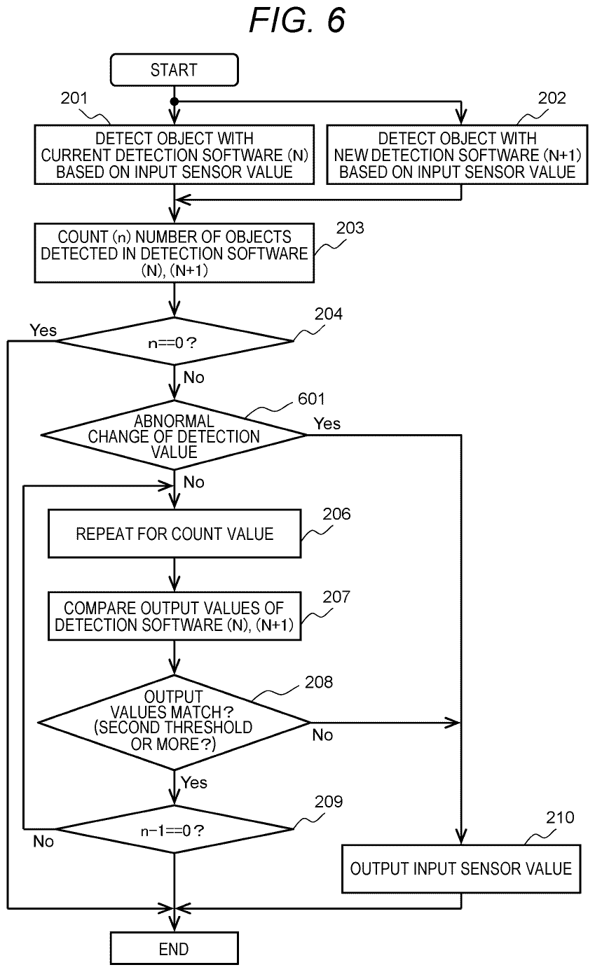

FIG. 6 is a flowchart of processing executed by the electronic control unit 1102 according to the second embodiment.

The first-threshold adjustment unit 109 of the electronic control unit 1102 not only counts the number of detected objects output by the current detection software unit 102 and the number of detected objects output by the new detection software unit 104, but also monitors a change in the number of detected objects to be output. For example, a degree of change such as a change in total count value and a change in the count value of detected objects for each type is confirmed. There may be a case where an object suddenly disappears or an object suddenly appears, but the presence or absence of an abnormal change such as sudden change, sudden increase, or sudden decrease is detected in consideration of a case where an object is invisible and undetected, or objects overlap complicatedly and erroneous detection frequently occurs (601). In a case where the abnormal change is detected, the input sensor value may be output without comparing the outputs of both pieces of software (210).

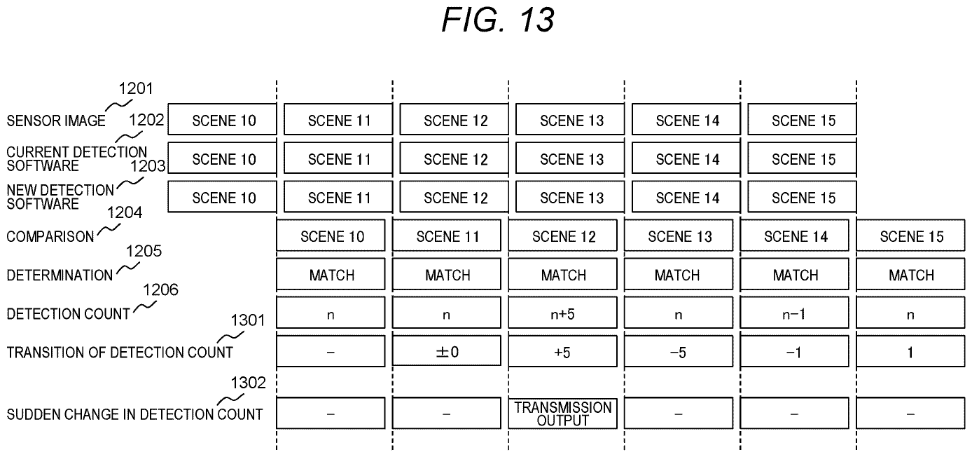

FIG. 13 is a timing chart from a sensor input to an output of a sensor value. Similarly to FIG. 12, a processing start timing and a processing end timing are simply illustrated. An image of a scene 10 to a scene 15 is input as the input sensor image 1201, a transition 1301 of the detection count is monitored, a sudden change 1302 in the detection count is detected to extract the “scene 12”, and the image is determined as an image to be output and transmitted. Here, as a method of detecting the sudden change, it is possible to allow for a slight change and compare the detection count with that at one or two time points earlier to determine whether there is an increase or decrease of a predetermined threshold or more. As a result, it is possible to output, to the outside, the input sensor image of a case where there is a large change in the number of detected objects, in addition to a case where the presence of a mismatch is detected.

### Third Embodiment

Next, a third embodiment of the present invention will be described. In the third embodiment, a condition detection unit 701 is added to the configuration (FIG. 1) of the electronic control unit 1102 of the first embodiment. Note that, in the third embodiment, differences from the first embodiment will be mainly described, and the same configurations and processing as those in the first embodiment will be denoted by the same reference numerals, and description thereof will be omitted.

### Electronic Control Unit: Under Specific Condition

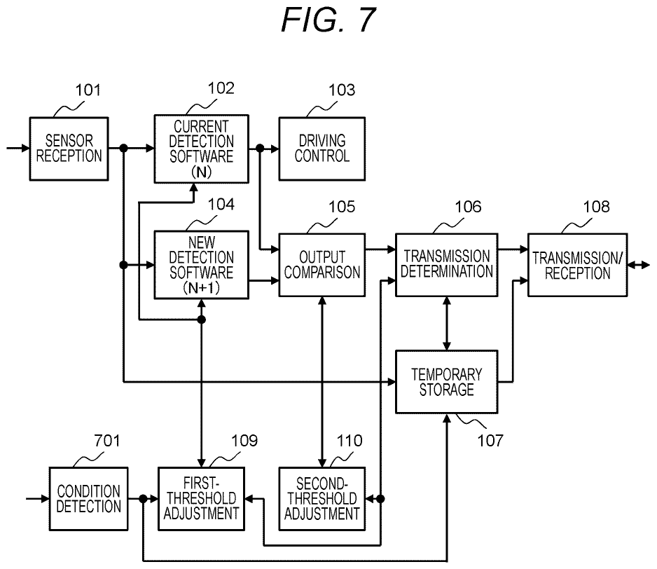

FIG. 7 is a block diagram illustrating a configuration of the electronic control unit 1102 of the third embodiment.

The electronic control unit 1102 of the third embodiment includes the sensor reception unit 101, the current detection software unit 102, the driving control unit 103, the new detection software unit 104, the output comparison unit 105, the transmission determination unit 106, the temporary storage unit 107, the transmission/reception unit 108, the first-threshold adjustment unit 109, the second-threshold adjustment unit 110, and the condition detection unit 701.

The condition detection unit 701 detects environmental information such as time, position, weather, and visibility. These pieces of environment information may be managed as identification information added to the input sensor value, or may be added to the sensor value to be output to the outside. For example, in a case where the visibility is poor, there is a possibility that the accuracy of object detection decreases and the number of detected objects decreases. As a result, the number of comparison items also decreases, the number of detected mismatches decreases, and there is a possibility of overlooking software improvements. Therefore, the number of detected mismatches can be increased by changing the threshold according to the surrounding environment. For example, the first-threshold adjustment unit 109 and the second-threshold adjustment unit 110 can be controlled so as to loosen the first threshold (detection threshold) to be compared with the number of detected objects or to tighten the second threshold (comparison threshold) used for match determination, thereby performing control so as to increase the number of detected mismatches. As a result, even in a case where the detection accuracy decreases, a necessary input sensor image can be output to the outside.

### Fourth Embodiment

Next, a fourth embodiment of the present invention will be described. In the fourth embodiment, a condition comparison unit 801 is added to the configuration (FIG. 7) of the electronic control unit 1102 of the third embodiment. Note that, in the fourth embodiment, differences from the third embodiment will be mainly described, and the same configurations and processing as those in the first and third embodiments are denoted by the same reference numerals, and description thereof will be omitted.

### Electronic Control Unit: Storage Condition Comparison 1

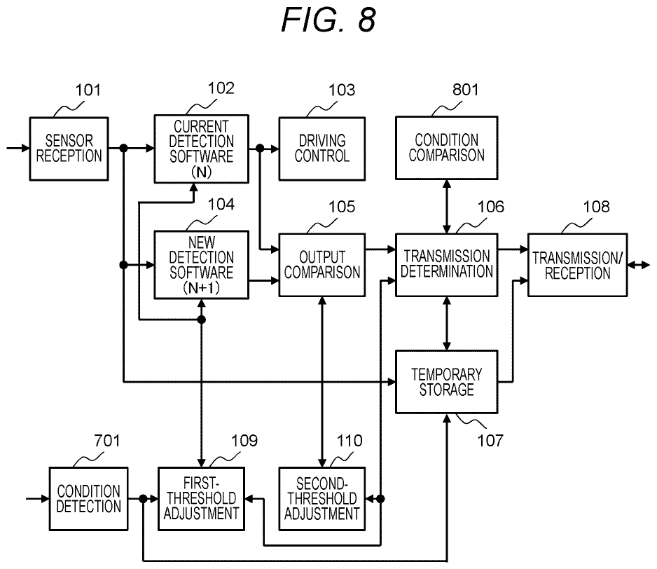

FIG. 8 is a block diagram illustrating a configuration of the electronic control unit 1102 of the fourth embodiment.

The electronic control unit 1102 of the fourth embodiment includes the sensor reception unit 101, the current detection software unit 102, the driving control unit 103, the new detection software unit 104, the output comparison unit 105, the transmission determination unit 106, the temporary storage unit 107, the transmission/reception unit 108, the first-threshold adjustment unit 109, the second-threshold adjustment unit 110, the condition detection unit 701, and the condition comparison unit 801.

The various conditions detected by the condition detection unit 701 are temporarily stored in the temporary storage unit 107 or the condition comparison unit 801, and are compared with the detection condition of the input image by the condition comparison unit 801.

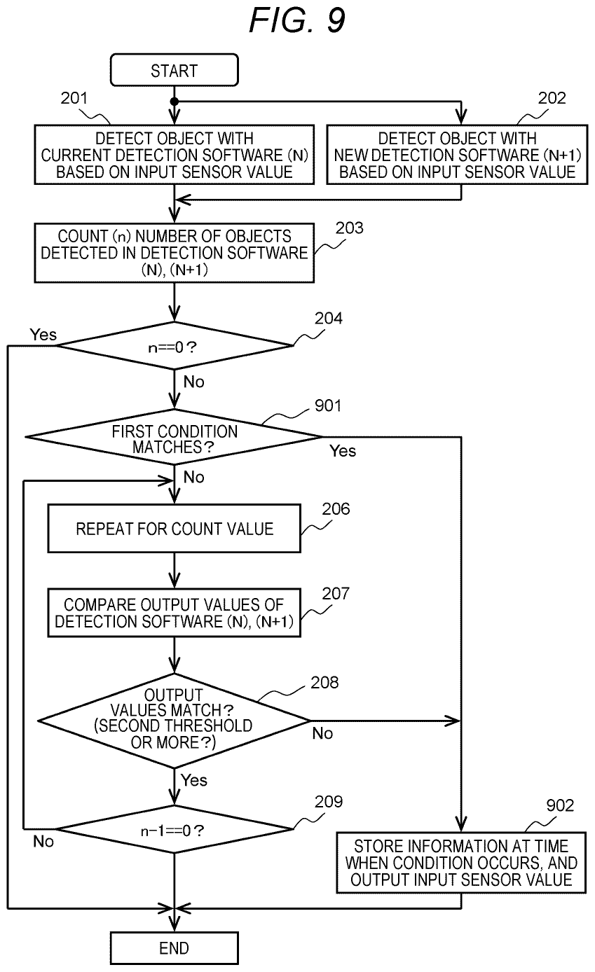

FIG. 9 is a flowchart of processing executed by the electronic control unit 1102 according to the fourth embodiment.

A difference from FIG. 2 of the first embodiment is that the environment in which the object is detected is compared with a stored first condition (901) without comparing the number of detected objects with the first threshold (205). For example, the condition comparison unit 801 stores, as the first condition, the time and place where the mismatch detection has occurred in the past. By comparison with the first condition, it is possible to extract an image of a time zone or a place in which a mismatch has occurred before, and thus, it is possible to easily perform re-verification under a condition in which the mismatch has occurred before. In addition, even in verification of new version of software, whether improvement is made under the same condition can be easily determined by using the condition stored in a previous version. In addition, even in the same time zone or place, it is possible to verify whether a problem occurs in environments with different traffic volumes or the like, whether there is another risk, or the like. Here, as the first condition to be stored, the time and place have been described, but other conditions may be used as long as the conditions are classifiable and have high reproducibility. As a result, it is possible to output, to the outside, the input sensor image of a case where the same environment as the condition where the mismatch has occurred in the past is detected, in addition to a case where the presence of the mismatch is detected.

### Fifth Embodiment

Next, a fifth embodiment of the present invention will be described. The fifth embodiment is different from the fourth embodiment in the determination by the condition comparison unit 801. Note that, in the fifth embodiment, differences from the fourth embodiment will be mainly described, and the same configurations and processing as those in the fourth embodiment will be denoted by the same reference numerals, and description thereof will be omitted.

### Electronic Control Unit: Storage Condition Comparison 2

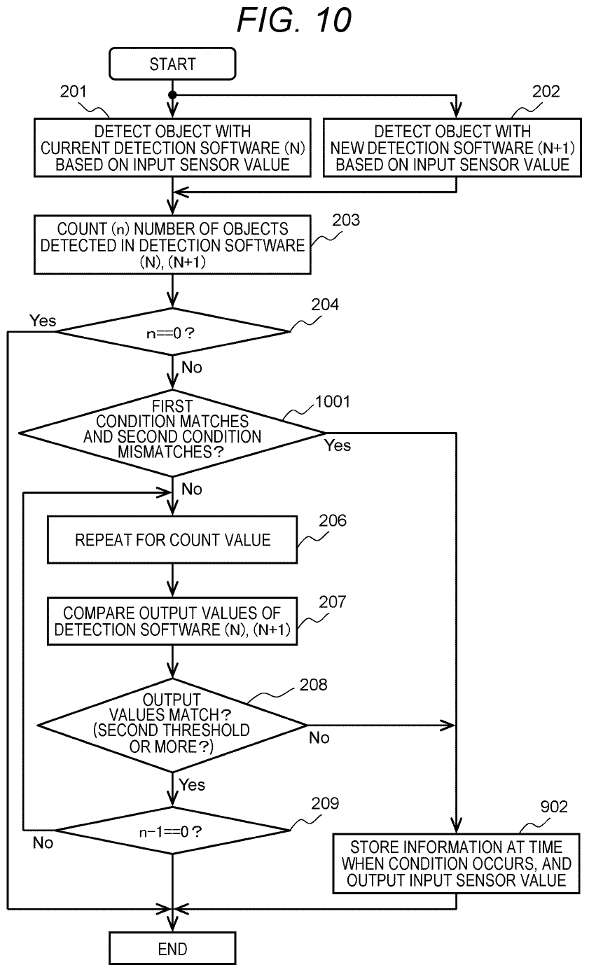

FIG. 10 is a flowchart of processing executed by the electronic control unit 1102 according to the fifth embodiment.

A difference from FIG. 9 of the fourth embodiment is that it is determined whether the environment matches the first condition and does not match the second condition (1001) without the comparison about whether the environment matches the first condition (901). For example, the condition comparison unit 801 stores, as the first condition, the time and place where the mismatch detection has occurred in the past, and stores, as the second condition, weather and visibility. As a result, images having different weather conditions can be extracted even in a time zone or a place where a mismatch has occurred before, so that it is possible to verify whether a problem occurs in different environments even in the same time zone or place. Although the time and place have been described as the first condition to be stored and the weather and visibility have been described as the second condition to be stored, other conditions may be used as long as the conditions are classifiable and have high reproducibility. As a result, it is possible to output, to the outside, the input sensor image of a case where different environment is detected under the condition where the mismatch has occurred in the past, in addition to a case where the presence of the mismatch is detected.

Note that, in the vehicle control system of FIG. 11, the single sensor 1101 and the single electronic control unit 1102 have been described. However, a plurality of sensors 1101 may be arranged in the vehicle 1104, and the observation results of the plurality of sensors 1101 may be input to the single electronic control unit 1102, or the observation results of the plurality of sensors 1101 may be input to a plurality of electronic control units 1102. In addition, a configuration may be made in combination with the electronic control unit 1102 that does not compare the previous and new software.

In addition, in the embodiments described above, the output comparison unit 105 and the transmission determination unit 106 are provided in the electronic control unit 1102, the input sensor value is output to an external server or the like, and reprocessing is performed in the external reprocessing unit 1103. However, the output comparison unit 105 and the transmission determination unit 106 may be provided in the external reprocessing unit 1103. In this case, the input sensor value and all the output values of respective detection software units may be output to the external reprocessing unit 1103, and the external reprocessing unit 1103 may select data to be used for reprocessing with reference to the comparison result and the determination result.

In addition, although the description has been given about the comparison of the output values of the object detection software, the comparison of the output values of the software used for the recognition processing, the route planning, and the control command can be realized with a similar configuration.

In addition, the description has been given assuming that the new detection software is Version. N and the previous detection software is Version. N+1, but the new detection software is only required to be partially different from the previous software, and even in a case where an initial value is different in the software of the same version or in a case where a setting value is different in the software of the same version, the function of the software can be verified by a similar configuration. Any software may be compared as long as the software is used for the purpose of function verification of software different from the software of the previous version.

Not only in a case where the output of the new detection software and the output of the previous detection software do not match, but also in a case where the output results match, the vehicle control system of the present embodiment outputs sensor information on the basis of the detection condition and the transition condition of the number of detected objects. Therefore, it is possible to simply output a case suspected of erroneous detection or non-detection, and it is possible to improve the quality of the software by performing re-verification in the external reprocessing unit 1103.

Note that the present invention is not limited to the above-described embodiments, and includes various modifications and equivalent configurations within the spirit of the appended claims. For example, the above-described embodiments have been described in detail for easy understanding of the present invention, and the present invention is not necessarily limited to those having all the described configurations. In addition, a part of the configuration of a certain embodiment may be replaced with the configuration of another embodiment. In addition, the configuration of another embodiment may be added to the configuration of a certain embodiment. In addition, a part of the configuration of each embodiment may be added, deleted, or replaced with another configuration.

In addition, a part or all of the above-described configurations, functions, processing units, processing means, and the like may be realized by hardware by, for example, designing with an integrated circuit, or may be realized by software by a processor interpreting and executing a program for realizing each function.

Information such as a program, a table, and a file for achieving each function can be stored in a storage device such as a memory, a hard disk, and a solid state drive (SSD), or a recording medium such as an IC card, an SD card, and a DVD.

In addition, the control lines and the information lines indicate what is considered to be necessary for the description, and do not necessarily indicate all the control lines and the t information lines necessary for the implementation. In practice, it may be considered that almost all the configurations are connected to each other.

### REFERENCE SIGNS LIST

101 sensor reception unit
102 current detection software unit
103 driving control unit
104 new detection software unit
105 output comparison unit
106 transmission determination unit
107 temporary storage unit
108 transmission/reception unit
109 first-threshold adjustment unit
110 second-threshold adjustment unit
401 data reception unit
402 temporary storage unit
403 new detection software unit
404 software correction unit
405 data transmission unit
701 condition detection unit
801 condition comparison unit
1101 sensor
1102 electronic control unit
1103 external reprocessing unit
1104 vehicle
1105 server

1. An electronic control unit that controls a vehicle, comprising:
a processor that executes software; and a storage device that stores the software, wherein
the electronic control unit is connected to a verification system that verifies software by using information from the electronic control unit, and
the electronic control unit further comprises:
first software that executes arithmetic processing based on time-series sensor information, a processing result of the first software being used for vehicle control;
second software that is executed in parallel with the first software and outputs a result of the arithmetic processing based on the sensor information, the processing result of the second software being not used for vehicle control;
a comparison unit that compares the processing result of the first software with the processing result of the second software; and
a transmission determination unit that determines to transmit, to the verification system, sensor information corresponding to a processing result determined as a mismatch by the comparison unit, and further to transmit, to the verification system, sensor information corresponding to a processing result determined as a match by the comparison unit according to a number of pieces of information acquired from the sensor information.

2. The electronic control unit according to claim 1, further comprising:
a first adjustment unit that adjusts a detection threshold, wherein
the transmission determination unit compares the number of pieces of information acquired from the sensor information by the first software and the second software with the detection threshold and, in a case where the number of pieces of information acquired from the sensor information is larger than the detection threshold, determines to transmit the sensor information corresponding to the processing result determined as a match by the comparison unit.

3. The electronic control unit according to claim 1, wherein
the transmission determination unit determines to transmit the sensor information corresponding to the processing result determined as a match by the comparison unit in a certain period after the processing result determined as a mismatch by the comparison unit.

4. The electronic control unit according to claim 1, wherein
the transmission determination unit determines to transmit the sensor information corresponding to the processing result determined as a match by the comparison unit in a certain period before and after the processing result determined as a mismatch by the comparison unit.

5. The electronic control unit according to claim 1, further comprising
a first adjustment unit that adjusts a detection threshold, wherein
the transmission determination unit compares the number of pieces of information acquired from the sensor information by the first software and the second software with the detection threshold, and determines to transmit the sensor information corresponding to the processing result determined as a match by the comparison unit, on a basis of transition of the number of pieces of information acquired from the sensor information.

6. The electronic control unit according to claim 1, further comprising
a first adjustment unit that adjusts a detection threshold according to a surrounding environment of the vehicle, wherein
the transmission determination unit compares the number of pieces of information acquired from the sensor information by the first software and the second software with the adjusted detection threshold, and in a case where the number of pieces of information acquired from the sensor information is larger than the detection threshold, determines to transmit the sensor information corresponding to the processing result determined as a match by the comparison unit.

7. The electronic control unit according to claim 1, further comprising
a second adjustment unit that adjusts a comparison threshold, which is used by the comparison unit to compare the processing results, according to a surrounding environment of the vehicle, wherein
the comparison unit compares the processing result of the first software with the processing result of the second software by using the adjusted comparison threshold, and determines whether the processing results match.

8. The electronic control unit according to claim 1, further comprising:
a condition detection unit that detects a surrounding environment of the vehicle, wherein
the comparison unit stores, as an operation condition, a surrounding environment at time of being determined as a mismatch, and
in a case where the surrounding environment detected by the condition detection unit matches the operation condition stored in the comparison unit, the transmission determination unit determines to transmit the sensor information corresponding to the processing result determined as a match by the comparison unit.

9. The electronic control unit according to claim 1, further comprising:
a condition detection unit that detects a surrounding environment of the vehicle, wherein
the comparison unit stores, as a first operation condition and a second operation condition, a first surrounding environment and a second surrounding environment at time of being determined as a mismatch, respectively, and
in a case where the surrounding environment detected by the condition detection unit matches the first operation condition stored in the comparison unit and does not match the second operation condition, the transmission determination unit determines to transmit the sensor information corresponding to the processing result determined as a match by the comparison unit.

10. The electronic control unit according to claim 1, wherein
the processing result of the first software, the processing result of the second software, and a comparison result of the comparison unit are added to the sensor information transmitted to the verification system.

11. The electronic control unit according to claim 1, further comprising:
a condition detection unit that detects a surrounding environment of the vehicle, wherein
the processing result of the first software, the processing result of the second software, a comparison result of the comparison unit, and a detection result of the condition detection unit are added to the sensor information transmitted to the verification system.

12. A vehicle control system comprising:
an electronic control unit that controls a vehicle; and
a verification device that verifies software by using information from the electronic control unit, wherein
the electronic control unit includes
first software that executes arithmetic processing based on time-series sensor information, a processing result of the first software being used for vehicle control,
second software that is executed in parallel with the first software and outputs a result of the arithmetic processing based on the sensor information, the processing result of the second software being not used for vehicle control,
a comparison unit that compares the processing result of the first software with the processing result of the second software, and
a transmission determination unit that determines to transmit, to the verification device, sensor information corresponding to a processing result determined as a mismatch by the comparison unit, and further to transmit, to the verification device, sensor information corresponding to a processing result determined as a match by the comparison unit according to a number of pieces of information acquired from the sensor information, and
the verification device executes arithmetic processing by the second software by using the sensor information transmitted from the electronic control unit, and outputs information regarding the processing result of the second software.

13. A software verification method executed by a vehicle control system, wherein
the vehicle control system includes an electronic control unit that controls a vehicle and a verification device that verifies software by using information from the electronic control unit, and
the software verification method comprises:
executing, by first software in which a processing result is used for vehicle control, arithmetic processing for vehicle control based on time-series sensor information;
executing, by the electronic control unit, second software in which a processing result is not used for vehicle control in parallel with the first software, and outputting a result of the arithmetic processing based on the sensor information;
comparing, by the electronic control unit, the processing result of the first software with the processing result of the second software;
by the electronic control unit, transmitting, to the verification device, sensor information corresponding to a processing result determined as a mismatch by the comparison, and further transmitting, to the verification device, sensor information corresponding to a processing result determined as a match by the comparison according to a number of pieces of information acquired from the sensor information;
executing, by the verification device, arithmetic processing by the second software by using the sensor information transmitted from the electronic control unit; and
outputting, by the verification device, information regarding the processing result of the second software.
